(19) United States
(12) Patent Application Publication
(10) Pub. No.: US 2026/0111796 A1
(43) Pub. Date: Apr. 23, 2026

(54) ACTIVE EXAMPLE SELECTION FOR KNOWLEDGE DISTILLATION

(71) Applicant: GDM Holding LLC, Mountain View, CA (US)

(72) Inventors: Vishaal Udandarao, Tuebingen (DE); Nikhil Parthasarathy, London (GB); Sion Talfan Evans, Penycae, Swansea (GB); Muhammad Ferjad Naeem, Zurich (CH); Olivier Jean Henaff, London (GB); Yongqin Xian, Zurich (CH); Alessio Tonioni, Zurich (CH); Federico Tombari, Zug (CH)

(21) Appl. No.: 19/346,241

(22) Filed: Sep. 30, 2025

Related U.S. Application Data
(60) Provisional application No. 63/702,141, filed on Oct. 1, 2024.

(51) Int. Cl. G06N 20/00

(52) U.S. Cl. CPC G06N 20/00

(57) ABSTRACT

Methods, systems, and apparatus for training a smaller machine learning model through contrastive learning. The method includes obtaining data specifying a larger machine learning model, wherein the larger machine learning model has been trained through contrastive learning; obtaining a training dataset comprising a plurality of training examples; and training the smaller machine learning model on the training dataset, the training comprising, at each of a plurality of training iterations: generating a batch for the training iteration that comprises a subset of the plurality of training examples, the generating comprising selecting the subset of training examples according to performing an active data selection procedure based on respective contrastive losses of the larger machine learning model on one or more candidate batches that each include a respective subset of training examples from the training dataset; and training the smaller machine learning model on a contrastive loss function using the batch.

### CROSS-REFERENCE TO RELATED APPLICATION

This application claims priority to U.S. Provisional Application No. 63/702,141, filed on Oct. 1, 2024. The disclosure of the prior application is considered part of and is incorporated by reference in the disclosure of this application.

### BACKGROUND

This specification relates to processing inputs using neural networks to generate output sequences.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

### SUMMARY

This specification describes a system implemented as computer programs on one or more computers in one or more locations that trains a smaller machine learning model (e.g., a student machine learning model) by leveraging a larger machine learning model (e.g., a teacher machine learning model) to generate training batches using an active data selection procedure based on a contrastive loss.

In particular, the system obtains data specifying a larger machine learning model, where the larger machine learning model has been trained through contrastive learning, and where the larger machine learning model has more parameters than the smaller machine learning model. The system then obtains a training dataset that includes multiple training examples, and the system trains the smaller machine learning model on the training dataset.

The training includes, at each of multiple training iterations, generating a batch for the training iteration that includes a subset of the multiple training examples. Generating the batch includes selecting the subset of training examples according to performing an active data selection procedure based on respective contrastive losses of the larger machine learning model on one or more candidate batches. Each candidate batch includes a respective subset of training examples from the training dataset. The system then trains the smaller machine learning model on a contrastive loss function using the batch.

In some implementations, training the smaller machine learning model on the training dataset includes holding the larger machine learning model fixed during the training.

In some implementations, performing the active data selection procedure includes determining, for each of the one or more of the training examples in the training dataset, a respective active data selection conditional score, where the active data selection conditional score measures a benefit to the training of the smaller machine learning model of including the training example in the batch given that at least a subset of the training examples in the training dataset are also included in the batch.

In some implementations, generating the batch for the training iteration includes adding a respective set of training examples to the batch at each of the multiple training iterations.

In some implementations, selecting the subset of training examples includes, at one or more of the multiple training iterations, computing a respective active data selection conditional score for each of the training examples that are not included in the batch as of the iteration, where the active data selection conditional score measures a benefit to the training of the smaller machine learning model of including the training example in the batch given that at least the training examples that are already included in the batch as of the iteration are also included in the batch, and selecting the respective set of training examples to be added to the batch at the iteration based on the respective active data selection conditional scores for the training examples that are not included in the batch.

In some implementations, selecting the respective set of training examples to be added includes determining a respective probability for each of the training examples that are not included in the batch using the respective active data selection conditional scores for the training examples that are not included in the batch, and sampling the respective set of training examples in accordance with the respective probabilities.

In some implementations, determining, for each of one or more of the training examples in the training dataset, a respective active selection conditional score includes, for each of the one or more training examples, determining a first score that measures a contrastive loss of the larger machine learning model computed for a batch of training examples that includes the given training example and at least the subset of the training examples of the training dataset.

In some implementations, for each training examples in the subset, respective outputs of the larger machine learning model for the training example have been pre-computed and stored in a cache, and the method further includes computing the first score using outputs retrieved from the cache.

In some implementations, determining, for each of one or more of the training examples in the training data set, a respective active data selection conditional score further comprises, for each of the one or more training examples, determining a second score that measures a contrastive loss of the smaller machine learning model computed for the batch of training examples that includes the given training example and at least the subset of the training examples of the training dataset.

In some implementations, where the contrastive loss of the larger machine learning model on one of the candidate batches depends on, for each training example in the candidate batch, (i) a similarity between the first and second inputs in the training example and (ii) a respective similarity between the first input in the training example and each second input in each other training example that is included in the candidate batch.

In some implementations, the contrastive loss function is a softmax contrastive loss function.

In some implementations, the contrastive loss function is a sigmoid contrastive loss function.

In some implementations, training the smaller machine learning model includes training the smaller machine learning model on a softmax distillation objective using a second subset of training examples.

In some implementations, training the smaller machine learning model on a softmax distillation objective includes processing the second subset of training examples using the larger machine learning model to generate the corresponding larger machine learning outputs, processing the second subset of training examples using the smaller machine learning model to generate corresponding smaller machine learning outputs, and training the smaller machine learning model on a cross-entropy loss between the larger machine learning outputs and the smaller machine learning outputs.

In some implementations, the larger machine learning outputs include a set of larger similarity scores for each of the training examples in the second subset, and where the smaller machine learning outputs include a set of smaller similarity scores for each of the training examples in the second subset.

In some implementations, for each training example, the respective first input is of a first modality and the respective second input is of a second, different modality.

In some implementations, the first modality is one of an image, audio, video, or text.

In some implementations, the second modality is one of an image, audio, video, or text.

In some implementations, the method further includes processing one or more inputs using the trained smaller machine learning model to generate one or more embedding outputs for a downstream task.

Particular embodiments of the subject matter described in this specification can be implemented so as to realize one or more of the following advantages.

In existing techniques, a system can perform knowledge distillation by distilling a reference teacher machine learning model to a smaller student machine learning model. For example, a system can train the student machine learning model by using the teacher machine learning model to process multiple training examples. However, these techniques have demonstrated that a large difference in size (e.g., in the number of parameters) between the models can hinder training of the student machine learning model because the system must use a larger number of reference training examples to train the student machine learning model. As such, previous systems have generally limited the size of the teacher machine learning model used for knowledge distillation by relying on relatively smaller or mid-sized reference models because attempting to distill directly from a relatively large model to a much smaller student model may require too many training examples and may be computationally inefficient. That is, training large-scale machine learning models, particularly those employing contrastive learning objectives, presents significant technical challenges, such as computational cost (e.g., GPU/TPU hours) and energy consumption required for processing large training datasets. Another challenge that is specific to contrastive learning is that the effectiveness of a training example often depends on the other examples in the same batch because contrastive loss evaluates similarities and dissimilarities between embeddings within the batch.

Some conventional systems perform data curation by selecting “high-quality” training examples to more efficiently train a smaller machine learning model. Some existing systems rely on manual curation (e.g., manually selecting data points), which can be relatively unscalable and time-consuming. Other systems can select the training examples on a point-by-point basis using one or more scoring metrics. However, selecting individual training examples from a large dataset can be computationally expensive, and the scoring metrics may not accurately represent the benefit of training the student machine learning model using the particular training example given the context of the other training examples in the dataset. In particular, conventional selection strategies that do not account for intra-batch interactions often yield suboptimal training batches when used for contrastive learning, which can lead to slower convergence, greater computational costs, and less efficient model performance on downstream tasks (e.g., reduced image classification accuracy and/or lower precision in text-to-image retrieval).

In contrast, the described techniques leverage an active data selection procedure to efficiently distill knowledge from a larger machine learning model (e.g., a teacher machine learning model) to a smaller machine learning model (e.g., a student machine learning model). The system generates a batch that includes a selected subset of training examples from a training dataset based on respective contrastive losses of the larger machine learning model on one or more candidate batches from the training dataset. Unlike conventional methods, this joint example selection explicitly accounts for intra-batch dependencies between training examples, which results in the system evaluating training examples relative to those already included in the batch during batch selection iterations of constructing the batch.

In particular, the system selects the training examples for the batch by determining an active data selection conditional score that measures a benefit to the training of the smaller machine learning model in including the training example in the batch given a subset of the training examples already in the batch. This allows the system to select high-quality training examples in reference to the other training examples already in the batch. Thus, by curating high quality training examples using the active data selection conditional scores, the system can distill knowledge to the smaller machine learning model from the larger machine learning model while requiring fewer overall training examples. Because the smaller machine learning model is trained using fewer, higher-quality training examples, training the smaller machine learning model uses less compute (e.g., fewer forward passes and backward passes through the model), less memory to store candidate batches and intermediate embeddings, and less bandwidth to load and process training data. Accordingly, the system can incrementally add new subsets of training examples to the batch across successive batch selection iterations, which allows for increased efficiency and improved training of the smaller machine learning model while leveraging the size and representational capacity of the larger machine learning model.

In some examples, the active data selection score for each training example represents a “learnability” of each training example based on a combination of a first score and a second score. The first score measures a contrastive loss of the larger machine learning model for the training example given the training examples included in the batch, and the second score measures a contrastive loss of the smaller machine learning model for the training example given the training examples included in the batch. The active data selection conditional score can measure a difference between the first score and the second score.

The first score represents data that is “easy” to learn for the larger machine learning model (e.g., training examples with relatively low loss). In particular, the system can compute a negative loss for pre-computed outputs of the reference model by retrieving the outputs from a cache. Each training example can include two inputs, and the contrastive loss depends on a similarity between the inputs in the training example and their similarity relative to the first input in the training example and second inputs from other training examples in the batch.

The second score represents data that is “hard” to learn for the smaller machine learning model (e.g., training examples with relatively high contrastive loss). Thus, by including the first score as part of the conditional score, the system can discard “trivial” training examples that do not benefit the training of the smaller machine learning model relative to the “hard” training examples.

In some examples, the system trains the smaller machine learning model on a particular distillation objective by processing a second subset of training examples using both the smaller machine learning model and the larger machine learning model to generate corresponding outputs for both models. The system then trains the smaller machine learning model on a loss between the larger machine learning outputs and the smaller machine learning outputs. By aligning the outputs, the system can transfer semantic information and feature structure from the larger machine learning model into the smaller machine learning model, which accelerates convergence of the smaller machine learning model, reduces the amount of training data and compute power, and improves downstream task performance in comparison to training the smaller machine learning model on a contrastive loss alone.

Overall, the described techniques allow for the system to perform an active data selection procedure to generate a batch for training a smaller machine learning model through knowledge distillation. Importantly, the system effectively uses a larger machine learning model for knowledge distillation by implementing the active data selection procedure to select the training examples in the batch. That is, the active data selection procedure allows the system to leverage the larger machine learning model to determine active data selection conditional scores for the training examples of the batch, which enables the system to select high-quality training examples to efficiently distill knowledge to the smaller machine learning model.

As a particular example, the system can leverage the larger machine learning model to train a smaller machine learning model that can be more efficiently deployed on a device. For example, the smaller machine learning model can be deployed on an edge device or other computing devices with limited computational budget, limited processing resources, or constrained memory space, where the larger machine learning model could not be effectively deployed (e.g., because the parameters of the larger model would not fit in the memory of the device or because the latency would be too high for deployment). In such cases, the system can select the student machine learning model to conform to device-specific constraints, for example by constraining the model's parameter count to fit device memory, setting an inference-time latency target, or limiting computations to a specified number of operations per input.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example training system.

FIG. 2 shows an example diagram of the training process.

FIG. 3 is a flow diagram of an example process for training a smaller machine learning model through contrastive learning using a batch that includes a subset of training examples in a dataset.

FIG. 4 is a diagram of example results of training a smaller machine learning model using active data selection.

FIG. 5 is a diagram of example results of training a smaller machine learning model using active data selection for multimodal learnability.

Like reference numbers and designations in the various drawings indicate like elements.

### DETAILED DESCRIPTION

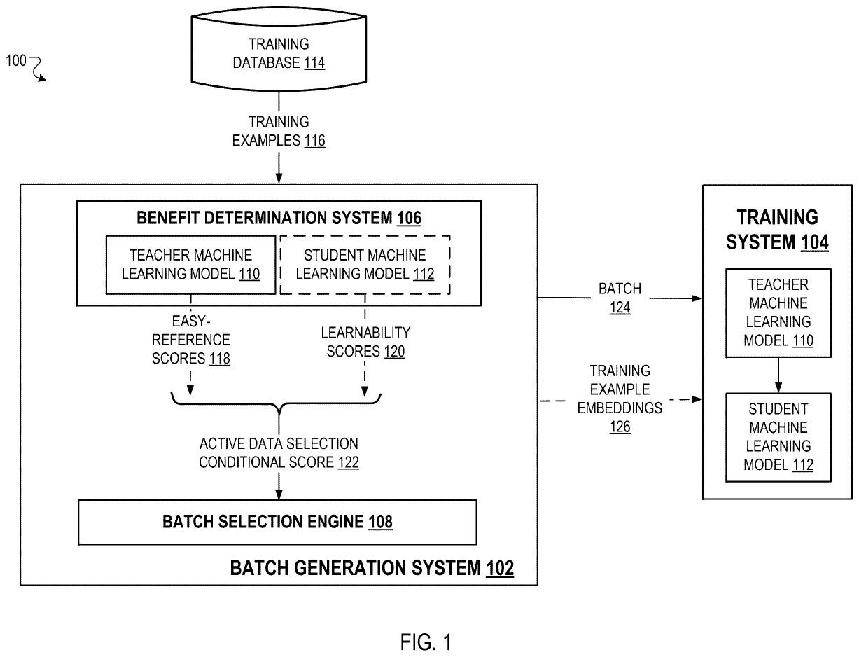

FIG. 1 shows an example system 100. The system 100 is an example of a system implemented as computer programs on one or more computers in one or more locations, in which the systems, components, and techniques described below can be implemented.

The system 100 includes a batch generation system 102, a training system 104, and a training database 114.

The system 100 trains a student machine learning model 112 over multiple training iterations using batches generated by the batch generation system 102 and processed by the training system 104.

The system 100 implements an active data selection procedure that jointly leverages a teacher machine learning model 110 and a student machine learning model 112 to address challenges such as noise, redundancy, and class imbalance in uncurated training data. In this way, the system 100 can prioritize training examples that are both high-quality and challenging, thereby improving robustness and enabling more efficient knowledge transfer from the teacher machine learning model 110 to the student machine learning model 112.

In particular, at each training iteration, the system 100 selects a subset of training examples 116 from the training database 114 to generate a batch 124, and the system 100 trains the student machine learning model 112 on the batch 124. That is, the system 100 selects the subset of training examples 116 by performing an active data selection procedure. The active data selection procedure is based on respective contrastive losses of the teacher machine learning model 110 on one or more candidate batches, where each candidate batch includes a respective subset of training examples 116. In this case, the system 100 holds the teacher machine learning model 110 fixed during training.

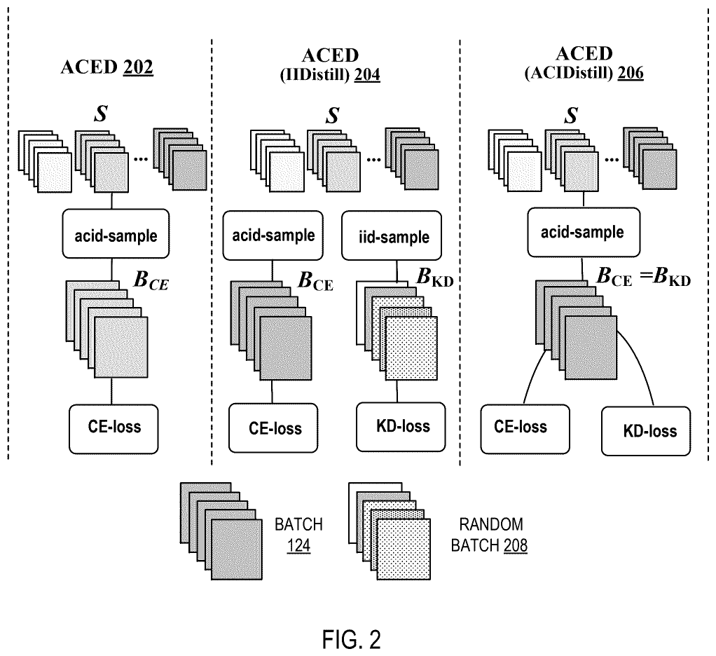

The system can perform the subset selection incrementally during construction of the batch 124, where the system re-evaluates the active data selection conditional scores at each successive batch selection iteration. That is, a training iteration refers to a full training step in which the student machine learning model 112 is updated using the completed batch 124, and a batch selection iteration refers to an incremental step during construction of that batch 124 in which the system re-evaluates scores and adds new subsets of training examples. The system 100 then trains the student machine learning model 112 on a contrastive loss function using the batch 124, as described in further detail below with reference to FIG. 2.

In some examples, the system 100 can sample from the same training dataset (e.g., the entire set of training examples 116) at each training iteration to generate the batch 124 for training the student machine learning model 112. In other examples, the system 100 can sample from different subsets of the training dataset at different training iterations to generate the batch 124 for training the student machine learning model 112.

The training database 114 stores training examples 116 for training the machine learning models. Each training example 116 can include two inputs. The first input is of a first modality, and the second input is of a second modality. The modality can be one of an image, audio, video, or text. The first modality can be the same as or different from the second modality. The modalities can each be, e.g., one of an image, audio, video, text, or other appropriate modality that can be represented in the input to a neural network. For example, a training example can include an image and a corresponding descriptive text caption, an audio signal and a corresponding text transcript, a video segment and a corresponding action label, or a query string and a corresponding ground-truth response passage.

The student machine learning model 112 can be an embedding neural network with any appropriate architecture that includes multiple layers and processes an input to generate an embedding output for the input. An embedding, as used in this specification, is an ordered collection of numerical values, e.g., a vector of numerical values, that has a predetermined dimensionality. The student machine learning model 112 can include one or more Transformer blocks. For example, the student machine learning model 112 can be a text embedding neural network that maps a text input to an embedding output. In another example, the student machine learning model 112 can be an image embedding neural network that maps an input image to an embedding output. In another example, the student machine learning model 112 can be a multimodal embedding neural network that maps inputs of different modalities to a shared embedding output, i.e., an output in a shared embedding space. In this case, the student machine learning model 112 can include, for example, a first input encoder that encodes inputs of a first modality into an embedding in an embedding space and a second input encoder that encodes inputs of a second modality into an embedding in the same or a different embedding space.

In some examples, the system can select the student machine learning model 112 based on hardware criteria associated with a target deployment device. The hardware criteria can include one or more of: a maximum memory capacity (e.g., RAM or VRAM), a maximum processing latency per inference, a maximum number of floating-point operations per inference, a maximum power budget or thermal envelope, computational throughput of an available accelerator (e.g., GPU, TPU, or CPU), and network bandwidth for transferring model parameters or embeddings. The system can select an architecture and configuration (e.g., number of layers, hidden dimensions, attention heads, quantization level, or pruning ratio) for the student machine learning model 112 that satisfies these criteria while maintaining task performance. That is, because the active data selection procedure reduces the number of training examples needed and improves convergence, the system can select a smaller architecture that meets the hardware criteria without incurring unacceptable loss in downstream performance.

The teacher machine learning model 110 can be an embedding neural network with any appropriate architecture with any appropriate architecture that includes multiple layers and processes an input to generate an embedding output for the input. In general, the teacher machine learning model 110 has more parameters than the student machine learning model 112, for example by having more layers, a larger internal dimension, a greater computational capacity, or a combination thereof. The system 100 can leverage the teacher machine learning model 110 to improve the performance of the smaller student machine learning model 112. For example, both models can be convolutional neural networks, self-attention-based neural networks (e.g., Transformers), or recurrent neural networks, with the student machine learning model 112 having fewer parameters due to fewer layers, smaller internal representation sizes (e.g., fewer filters in a convolutional layer or smaller query/key/value dimensions in a Transformer), or both.

The system 100 obtains data that specifies the teacher machine learning model 110. The data can include information identifying the architecture of the teacher machine learning model 110 (e.g., a convolutional network, a Transformer, etc.), the values of parameters of the teacher machine learning model 110, and/or pre-computed training example embeddings 126 of the teacher machine learning model 110. In particular, the system 100 can retrieve the training example embeddings 126 generated by the teacher machine learning model 110 for one or more training examples 116 stored in a cache.

In some examples, the data can include configuration information of the teacher machine learning model 110, such as a size of the internal representations (e.g., dimensionality of embeddings), a number of layers, or other hyperparameters that define the computational capacity of the teacher machine learning model 110.

The batch generation system 102 includes a benefit determination system 106 that computes active data selection conditional scores 122 for the training examples 116 and a batch selection engine 108 that selects a subset of training examples 116 based on the active data selection conditional scores 122. The benefit determination system 106 can include the teacher machine learning model 110 and, in some examples, the student machine learning model 112.

During construction of a batch 124 at each training iteration, the batch generation system 102 performs the active data selection procedure to generate the batch 124. The benefit determination system 106 computes active data selection conditional scores 122 for candidate training examples 116. Each active data selection conditional score 122 represents the benefit to the training of the student machine learning model 112 of including a given training example 116 in the batch 124, given that at least a subset of other training examples 116 are also included in the batch 124. These active data selection conditional scores 122 can be derived from easy-reference scores 118 generated by the teacher machine learning model 110, learnability scores 120 generated by the student machine learning model 112, or a combination of both, as described in greater detail with reference to FIG. 2.

In particular, the benefit determination system 106 can use the teacher machine learning model 110 to generate the easy-reference scores 118. That is, the teacher machine learning model 110 remains fixed during training and only provides easy-reference scores 118 to the benefit determination system 106 without being updated along with the student machine learning model 112. Each of the easy-reference scores 118 measure a contrastive loss of the teacher machine learning model 110 for a training example 116 given the other training examples included in the batch 124, as described in further detail below with reference to FIG. 2. In some examples, the benefit determination system 106 uses the student machine learning model 112 to directly contribute to the active data selection procedure by generating the learnability scores 120. Each of the learnability scores 120 measures a second score that corresponds to a contrastive loss of the student machine learning model 112 for a training example 116 given the other training examples included in the batch 124.

The batch selection engine 108 then uses the active data selection conditional scores 122 to select one or more of the candidate training examples 116 for inclusion in the batch 124. In some examples, the batch selection engine 108 performs selection of the training examples 116 for the batch 124 incrementally at successive batch selection iterations during construction of a single batch 124 for a given training iteration. For example, the batch selection engine 108 can rank the candidate training examples 116 by their active data selection conditional scores 122 and selects the training examples 116 with the highest values. In some other examples, the batch selection engine 108 can determine a probability distribution over the candidate examples based on the active data selection conditional scores 122 and sample the training examples 114 in accordance with the distribution.

In some examples, while generating the single batch 124 for a training iteration, the batch generation system 102 can generate updated active data selection conditional scores 122 for training examples 116 that have not yet been included in the batch 124. The batch selection engine 108 then selects the training examples 116 for inclusion in the batch 124 based on their respective active data selection conditional scores 122. That is, the system performs re-evaluation during the construction of a batch 124, not across separate training iterations. At each batch selection iteration, the benefit determination system 106 can re-evaluate these candidate training examples 116 in the context of the training examples 116 already selected, as the benefit of adding a new training example can depend on the composition of the partial batch 124. The batch selection engine 108 then incrementally adds new subsets of training examples 116 at successive batch selection iterations during construction of the batch 124 based on the updated active data selection conditional scores 122, which allows the batch generation system 102 to adaptively refine the batch 124. This incremental approach improves efficiency by prioritizing examples that provide the greatest marginal benefit to the student machine learning model 112, while avoiding redundancy among selected examples.

The system 100 can then use the training system 104 to train the student machine learning model 112 using the selected batch 124. In general, the student machine learning model 112 can be trained on a contrastive loss function using the batch 124. The contrastive loss can take different forms depending on implementation. For example, the contrastive loss can be a softmax loss, as used in ALIGN (Scaling Up Visual and Vision-Language Representation Learning with Noisy Text Supervision, Jia, et al., 2021) and PaLI (PaLI: A Jointly-Scaled Multilingual Language-Image Model, Chen, et al., 2022). In another example, the contrastive loss can be a sigmoid loss, as described in Sigmoid Loss for Language Image Pre-Training (Zhai, et al., 2023). In another example, the contrastive loss can be a cross-entropy loss, as used in SimCLR (A Simple Framework for Contrastive Learning of Visual Representations, Chen, et al., 2020).

In some examples, the system 100 trains the student machine learning model 112 on both the contrastive loss function and a distillation loss function using the selected batch 124, which is referred to as Active Contrastive Implicit Distillation (ACID)), as described in further detail below with reference to FIG. 2. In some other examples, the system 100 can use different batches 124 for the contrastive loss and the distillation loss, respectively, which is referred to as Active Contrastive Example Distillation with Independent Implicit Distillation (ACED-IIDistill), as described in further detail below with reference to FIG. 2. In some other examples, the system 100 can use the same curated batch 124 for both the contrastive loss and the distillation loss, which is referred to as ACED-ACIDistill, as described in further detail below with reference to FIG. 2.

Advantageously, by generating the batch 124 through the active data selection procedure, the system 100 can effectively perform knowledge distillation during batch selection. That is, the active data selection procedure prioritizes training examples 116 that are high-quality for the teacher machine learning model 110 and challenging for the student machine learning model 112. This joint selection process yields active data selection conditional scores 122 that identify examples based on a benefit for training, which enables the system 100 to generate batches that allow for more efficient learning training. Thus, the curated batches reduce redundancy and noise, conserve computational and memory resources, and improve performance metrics such as semantic alignment across modalities, robustness to noisy inputs, and accuracy on specialized tasks. As a result, the student machine learning model 112 converges more quickly, requires fewer training examples, and achieves improved generalization on downstream multimodal tasks.

After the student machine learning model 112 has been trained, representations (“embeddings”) generated by the trained student machine learning model 1122 can be used to perform one or more downstream tasks.

In particular, the system can process the embeddings generated by the trained student machine learning model 112 using a downstream model for the corresponding downstream task. For example, the student machine learning model 112 can be used to generate embeddings for a generation task (e.g., text generation, image generation, audio signal generation, video generation, etc.), a classification task (e.g., image classification), an object detection task, an image segmentation task, a compression task, or a prediction task (e.g., depth prediction).

For example, the embeddings generated by the student machine learning model 112 can be used to train a generative neural network that generates new observations (of the same type as the input observations or a different type) conditioned on embeddings generated using the student machine learning model 112.

As yet another example, the embeddings can be used as a representation of the observation for a multi-modal task performed by a multi-modal neural network, e.g., a representation of an image or video in visual understanding tasks, e.g., image (or video)-text retrieval tasks, image (or video) classification tasks, image (or video) captioning tasks, and visual question answering tasks. The multi-modal neural network can be, e.g., a multi-modal sequence generation neural network, e.g., a multi-modal large language model (LLM), or a visual language model (VLM), or a different type of multi-modal neural network.

For example, after training the student machine learning model 112, the system can receive a query input for a downstream task. The query input can be of any modality, including an image, an audio signal, or a video segment, and optionally include other data, e.g., one or more other images, one or more inputs of a different modality, e.g., text or audio.

The system can process the query image using the trained student machine learning model 112 to generate an embedding of the query image as a set of text tokens.

The system can then provide the embedding of the query image as input to a downstream neural network configured to perform the downstream task.

The downstream neural network can generally be any neural network that is configured to process inputs that include text tokens from the vocabulary to generate outputs for the downstream task.

For example, the downstream neural network can be a language model neural network, e.g., a large language model neural network (LLM), or a visual language model neural network (VLM). The LLM can be, e.g., a multi-modal model that processes inputs that include tokens representing multiple different modalities of data, or can be a uni-modal model that processes inputs that include text tokens.

For example, the query input can include the query image and text and the downstream neural network can be an LLM. Thus, providing the embedding of the query image as input to the downstream neural network can include providing the embedding of the query image and the text from the query input as input to the LLM instead of directly providing the query image as part of the input. For example, the LLM can have been trained on text-only data and therefore not be able to directly process image data inputs.

As another example, the embeddings can be provided as input to a classifier, e.g., a classification neural network or other type of machine learning model, that is configured to classify the input as belonging to one or more of a set of classes, e.g., object classes.

The downstream task that is performed by the downstream neural network can be any of a variety of tasks, e.g., a multi-modal dialogue task, so that the image is part of a dialogue input submitted by a user to the system and the output generated by the downstream neural network is a response to be displayed to the user.

Other examples of downstream tasks include multi-modal zero-shot or few-shot learning tasks.

As one example, if the input to the neural network is a sequence of text, e.g., a sequence of words, phrases, characters, or word pieces, in one language, the output generated by the generative model may be a translation of the sequence of text into another language, i.e., a sequence of text in the other language that is a translation of the input sequence of text. That is, the system can process the embeddings generated by the student machine learning model 112, which represent the sequence of text, to generate the translation of the sequence of text. As a particular example, the task may be a multi-lingual machine translation task, where a single neural network is configured to translate between multiple different source languages-target language pairs. In this example, the source language text may be augmented with an identifier that indicates the target language into which the neural network should translate the source language text.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task (e.g., speech transcription), where the input is text in a natural language or features of text in a natural language and the network output is a spectrogram, a waveform, or other data defining audio of the text being spoken in the natural language.

In some cases, the machine learning task is a multi-modal processing task that requires processing multi-modal data. In general, multi-modal data is a combination of two or more different types of data, e.g., two or more of audio data, image data, text data, or graph data. As one example the multi-modal data may comprise audio-visual data, comprising a combination of pixels of an image or of video and audio data representing values of a digitized audio waveform. As another example the multi-modal data may comprise a combination of i) text data representing text in a natural language and ii) pixels of an image or of video or audio data representing values of an audio waveform. Optionally, but not necessarily, the different types of data may represent the same or overlapping objects using the different modalities (types), and when processing multi-modal data the data may be mapped into a common embedding space.

As a particular example, the task is a multi-modal processing task that requires processing both text and image inputs, so that the neural network includes both a computer vision neural network and a text processing neural network. That is, the target output to be generated by the computer vision neural network for a given image depends on one or more outputs generated by the text processing neural network for one or more corresponding text inputs (and vice versa). Examples of such tasks include open-vocabulary image classification, open-vocabulary object detection, image captioning, text-based image search, image-based retrieval, and so on.

In particular, where the input is one or more images, the system can perform object detection of one or more objects in the input images by processing the one or more embedding outputs of the student machine learning model 112, and the system can output one or more location indications for the one or more objects based on the detection.

More generally, the multi-modal processing task may correspond to any of the tasks previously described for any of the types of data making up the multi-modal combination. For example, an accuracy of the previously described tasks may be increased when the task is applied to multi-modal data combining the data for which the task has been previously described and another type of data. For example detection or classification of an object or event may be improved when data of multiple different types (modalities) is processed.

As another example, the embeddings generated by the trained student machine learning model 112 can be used as part of a generative model (e.g., a language model) to solve visual understanding tasks.

For example, the discrete representations can be used as a representation of the image in visual understanding tasks.

One example of a visual understanding task is an image-text retrieval task, where the input includes an image or text or both and the output is an image that is received from an image datastore.

As yet another example, the discrete representations can be used as a representation of the image in visual understanding tasks.

One example of a visual understanding task is an image-text retrieval task, where the input includes an image or text or both and the output is an image that is received from an image datastore.

Another example of a visual understanding task is an image classification task, where the input is an image and the output is an identification of objects depicted in the image.

Another example of a visual understanding task is an image captioning task, where the input is an image and the output describes in natural language the objects depicted in the image.

Another example of a visual understanding task is a visual question answering task, where the input is an image and a query about the image and the output is a response to the query.

As another example, the downstream task can be a video processing task that requires processing respective discrete representations generated by the image processing neural network of each video frame in an input video. For example, the task can be a video question answering task, a video classification task, an action recognition task, a video generation task, and so on.

As another example, the downstream task can be a compression task, where the input can be an audio signal, an image, or a video and the output is a compressed representation of the input. For example, the system can perform audio compression by processing the audio signal using the student machine learning model 112 to generate a compressed version of the audio signal (e.g., the embedding output). In another example, the system can perform image compression by processing the image using the student machine learning model 112 to generate a compressed version of the image (e.g., the embedding output). In another example, the system can perform video compression by processing the video using the student machine learning model 112 to generate a compressed version of the video (e.g., the embedding output).

As another example, the downstream task can be an image segmentation task, where the input can be an image and the output can be one or more locations (e.g., location indications) for one or more objects in the image. In particular, the system can perform object detection of one or more objects in input images by processing the one or more embedding outputs of the student machine learning model 112, and the system can output one or more location indications for the one or more objects within the image based on the detection.

As another example, the downstream task can be a command generation task for controlling a robot to perform a physical task that requires processing the one or more embedding outputs corresponding to the commands, where the input can be data associated with the robot and the output can be one or more commands for performing the physical task.

In practice, for any of these examples, the task to be performed by the neural network can be defined by (at least a part of) the network input, e.g., that is in the form of a prompt or a request, received by the neural network. In other words, the neural network will be able to perform any of these tasks when an appropriate prompt or request is received based on leveraging the embeddings of the trained student machine learning model 112.

FIG. 2 shows an example diagram of the training process.

The batch generation system 102 selects a subset of training examples 116 for the batch 124 using the active data selection procedure, and the training system 104 then trains the student machine learning model 112 on the selected batch 124 across multiple training iterations. In particular, during construction of the batch 124 at a given training iteration, the system can re-evaluate the active data selection conditional scores 122 at each batch selection iteration to incrementally refine the composition of the batch 124. This ensures that the benefit of adding a new training example is assessed in the context of the partial batch, rather than being determined across separate training iterations.

As shown in FIG. 2, the training system 104 can train the student machine learning model 112 using active contrastive example distillation (ACED) 206 where batches are curated using conditional scores, ACED with independent implicit distillation (ACED-IIDistill) 208 where separate curated batches are used for a contrastive loss and a distillation loss, and active contrastive implicit distillation (ACID) 210 where the same curated batch 124 is used for both losses, as described in further detail below.

The batch generation system 102 is configured to generate a batch 124 that includes a subset of training examples 116 from a training dataset based on respective active data selection conditional scores 122 computed for the candidate training examples 116. Each active data selection conditional scores 122 measures the relative benefit of including a given training example 116 in the batch 124 given that other training examples are also included, which allows the batch generation system 102 to jointly select examples that are both high-quality and informative. In some examples, the batch generation system 102 can also retrieve pre-computed training example embeddings 126 from the teacher machine learning model 110, which the system can use contrastive losses and generate easy-reference scores 118 as part of the conditional scoring process, as described in further detail below.

At each batch selection iteration during construction of the batch 124, the system can compute the active data selection conditional scores 122 for each training example 116 using the learnability scores 120, the easy-reference scores 118, or both. For example, the active data selection conditional scores 122 can measure a difference between the learnability score 120 (measuring how difficult a training example 116 is for the student machine learning model 112) and the easy-reference score 118 (measuring how well-formed the same example is for the teacher machine learning model 110), as described by Equation 1:

$${s}^{benefit} ( B \vert θ , {θ}^{*} ) = {s}^{h a r d} ( B \vert θ ) + {s}^{e a s y} ( B \vert {θ}^{*} ) = l ( B \vert θ ) - l ( B \vert {θ}^{*} ) \qquad ( 1 )$$

where s^{benefit} is the conditional score 122 for the training example 116 relative to the sub-batch B, θ represents the parameters of the student machine learning model 202, θ* represents the parameters of the teacher machine learning model 110, s^{hard}(B|θ) represents the learnability score 120, and s^{easy}(B|θ*) represents the easy-reference score 118. The system can then aggregate the conditional scores 122 across the training examples 116 in the batch 124 (e.g., by averaging the conditional scores 122) to obtain an overall score for the batch, as shown by Equation 2:

$$s ( B \vert θ , {θ}^{*} ) = \frac{1}{b} {Σ}_{i = I}^{b} s ( {x}_{i} \vert θ , {θ}^{*} , B ) \qquad ( 2 )$$

where b represents the number of training examples 116 in the sub-batch B, and the summation is over each training example xᵢ in B.

In particular, the learnability score 120 represents training examples 116 that are relatively “hard” for the student machine learning model 112 to learn at its current stage of training. The learnability score 120 is computed as a contrastive loss of the student machine learning model 112 for a candidate training example 116, relative to a sub-batch of other training examples 116 from the training dataset that are concurrently included in the same batch 124 during the current batch selection iteration. Thus, by including the learnability score 120 (e.g., the first score) as part of the conditional score, the system is less likely to select trivial training examples for the batch 124 that do not benefit the training of the student machine learning model 112 in comparison with the hard training examples (e.g., training examples 116 with relatively high contrastive loss).

The batch generation system 102 can compute the easy-reference scores 118 by evaluating the contrastive loss of the teacher machine learning model 110 for candidate training examples 116 relative to the other training examples 116 that are already included in the same batch 124 during the current batch selection iteration. The easy-reference scores 118 represent examples that are relatively “easy” for the teacher machine learning model 110. That is, the easy-reference score 118 represents the contrastive loss of the teacher machine learning model 110 on a given training example 116 conditioned on a subset of training examples 116 included in the batch 124. In particular, for a given training example 116, the batch generation system 102 computes the contrastive loss under the reference model when that training example 116 is grouped with other examples in the current partially constructed batch 124.

In some examples, the system can determine the active data selection conditional scores 122 in terms of weighting functions that emphasize the contribution of each training example 116 based on a respective predicted loss under the student machine learning model 112 and the teacher machine learning model 110. That is, the weighting functions can provide insight into how the easy-reference score 118 and the learnability score 120 can combine to form the active data selection conditional scores 122.

For example, an importance weight a(x) for a given training example x can be derived from its contrastive loss in the context of a sub-batch B, as shown by Equation 3:

$$a ( x \vert B ) = exp ( - l ( x \vert B , θ ) ) \qquad ( 3 )$$

where a(x|B) is an importance weight for training example x, l(x|B, θ) is the contrastive loss of the student machine learning model 112 for training example x in the context of sub-batch B, and the exponential ensures that examples with relatively lower student loss are given relatively higher weight. In some examples, a corresponding importance weight can be determined using the teacher machine learning model, as shown by Equation 4:

$$a ( x \vert B ) = exp ( - l ( x \vert B , {θ}^{*} ) ) \qquad ( 4 )$$

where l(x|B, θ*) is the contrastive loss of the teacher machine learning model 110 for training example x in the context of the sub-batch B. In some examples, the system can compute the active data selection conditional scores 122 in different forms, and then convert those scores into importance weights for ranking or sampling. For example, the system can compute the selection score based on (i) the contrastive loss of the student machine learning model (Equation 3), (ii) the contrastive loss of the teacher machine learning model (Equation 4), or (iii) the difference between the student loss and the teacher loss, as shown by Equation 5:

$$a ( x \vert B ) = exp ( l ( x \vert B , θ ) - l ( x \vert B , {θ}^{*} ) ) \qquad ( 5 )$$

In this way, examples that are difficult for the student machine learning model 112 (e.g., high student loss) but relatively easy for the teacher machine learning model 110 (e.g., low teacher loss) are given higher weight, which corresponds to the conditional benefit score 122 described above with reference to Equation 1. The batch selection engine 108 can then use these weights to rank the candidate training examples and select the highest-weight training examples, to define a probability distribution for sampling training examples to be added to the batch at the current batch selection iteration, or both.

In some examples, each training example 116 can include a pair of inputs of different modalities (e.g., an image and a corresponding text caption). In this case, the learnability score 120 can be based on a contrastive loss that depends both on (i) the similarity between the two inputs in the same training example 116 (the positive pair) and (ii) the respective similarities between the first input of that pair and the second inputs of the pairs from other training examples 116 included in the batch 124 (the negative pairs). That is, for a pair of inputs, the learnability score 120 reflects how difficult it is for the student machine learning model 112 to correctly align the positive pair relative to the negative pairs within the same batch.

In some examples, the student machine learning model 112 can include a pair of encoders configured to process the two inputs of each training example 116. For example, the system can process the respective first inputs (e.g., images, audio signals, or video frames) using a first encoder and process the respective second inputs (e.g., text captions or transcripts) using a second encoder. The system can generate embeddings for the paired inputs using the encoders, and the system can then use these embeddings to compute the learnability scores and, in combination with the embeddings of the teacher machine learning model 110, the active data selection conditional scores 122. Similarly, the teacher machine learning model 110 can include corresponding encoders for processing the same pairs of inputs to generate teacher embeddings. The teacher embeddings provide the basis for the easy-reference scores 118, which the system can combine with the learnability scores 120 to determine the conditional benefit of including each training example 116 in the batch 124 In some examples, the first encoder and the second encoder can correspond to different sets of layers or computation units within the student machine learning model 112, the teacher machine learning model 110, or both.

More generally, to compute contrastive losses for a set of examples when the student or teacher models include two encoders, the system encodes each input of a training example 116 into a normalized embedding using the two separate encoders. These embeddings and their pairwise similarities provide the foundation for the contrastive losses and the distillation losses used in training and for scoring used in batch selection, as shown by Equation 6:

$${z}_{i}^{i m g} = \frac{{f}^{i m g} ( {I}_{i} \vert θ )}{{‖ {f}^{i m g} ( {I}_{i} \vert θ ) ‖}_{2}} , {z}_{i}^{txt} = \frac{{f}^{txt} ( {T}_{i} \vert θ )}{{‖ {f}^{txt} ( {T}_{i} \vert θ ) ‖}_{2}} \qquad ( 6 )$$

where the first encoder

$${f}^{i m g}$$

parametrized by θ processes the first input lᵢ (e.g., an image) to generate the first normalized embedding

$${z}_{i}^{i m g} ,$$

and where the second encoder f^{txt} parametrized by θ processes the second input Tᵢ (e.g., text) to generate the second normalized embedding

$${z}_{i}^{txt} .$$

The system then computes a similarity score between the first normalized embedding and the second normalized embedding, as shown by Equation 7:

$${l}_{i j} ( θ ) = α {z}_{i}^{i m g} \cdot {z}_{j}^{txt} + β \qquad ( 7 )$$

where lᵢⱼ(θ) measures the similarity between the i-th image embedding and the j-th text embedding, scaled by a and shifted by β. Based on the similarity scores, the system 100 determines respective probabilities for aligning the image inputs with the text inputs and the text inputs with the image inputs, as shown by Equation 8:

$${p}_{i j}^{img \to txt} = \frac{exp ( {l}_{i j} )}{{Σ}_{k = 1}^{b} exp ( {l}_{i k} )} , {p}_{i j}^{txt \to img} = \frac{exp ( {l}_{i j} )}{{Σ}_{k = 1}^{b} exp ( {l}_{ki} )} , {p}_{ij}^{sig} = σ ( {l}_{i j} ) \qquad ( 8 )$$

represents the probability of the image i being paired with text j, obtained from a row-wise softmax operation over the candidate texts in the batch 124, where

$${p}_{i j}^{txt \to img}$$

represents the probability of the text j being paired with image i, obtained from a column-wise softmax operation over the candidate images in the batch 124, and where

$${p}_{i j}^{s i g}$$

is a binary similarity score obtained by applying a sigmoid function to the similarity score lᵢⱼ.

In some examples, for each training example 116 in the set, the benefit determination system 106 can pre-compute and store the outputs of the teacher machine learning model 110 in a cache, and the benefit determination system 106 can compute the easy-reference scores 118 using the outputs retrieved from the cache, which allows the system to compute the easy-reference scores 118 efficiently during batch selection.

The benefit determination system 106 can then provide the active data selection conditional scores 122 to the batch selection engine 108. At each of multiple selection iterations, the batch selection engine 108 can then select a set of training examples 116 to be added to the batch 124 at the selection iteration by determining a respective probability for each of the training examples 116 that are not included in the batch 124 using the respective active data selection conditional scores 122 for the set of training examples 116 and sample the sub-batch of training examples 116 based on the probabilities.

In some examples, at each batch selection iteration, the batch selection engine 108 can determine a number of training examples 116 to add to the batch 124 based on a pre-selected filtering ratio f. The filtering ratio represents the proportion of candidate training examples that are filtered out at each selection iteration relative to the total number of training examples in the candidate batch, as shown by Equation 9:

$$f = 1 - b / B , \qquad ( 9 )$$

where B is the size of the candidate batch (e.g., a super-batch) and b is the size of the subset selected for inclusion in the batch 124 at the current selection iteration. That is, the system can fix the filtering ratio fin advance, and the system can then compute the corresponding number of examples b=(1−f)B to select at that iteration. A relatively higher filtering ratio f results in a relatively smaller subset size b, such that a smaller percentage of training examples 116 are selected at each selection iteration.

The batch generation system 102 can then provide the batch 124 to the training system 104 for training the student machine learning model 112 on a contrastive loss function over multiple training iterations.

As shown in FIG. 2, the training system 104 can train the student machine learning model 112 by ACED 202 using a contrastive loss, by ACED-IIDistill 204 using different batches 124 for the contrastive loss and a distillation loss, ACED-ACIDistill 206 using the same batch 124 for the contrastive loss and the distillation loss, or a combination thereof.

In particular, the contrastive loss function can include a cross-entropy loss. For example, the contrastive loss function can be a softmax contrastive loss function, as shown by Equation 10:

$${ℒ}_{softmax} ( {x}_{i} ; B ) = - \frac{1}{2} ( {log p}_{ii}^{img \to txt} + {log p}_{ii}^{txt \to img} ) \qquad ( 10 )$$

where the system minimizes the negative log-likelihood of the correct image-text pair (i,i) under both the row-wise probability distribution

$${p}_{ii}^{img \to txt}$$

and the column-wise probability distribution

$${p}_{ii}^{txt \to img}$$

to encourage the correct image-text pair in the batch 124 to have the highest similarity relative to all other candidate pairs in the batch.

In another example, the contrastive loss function can be a sigmoid contrastive loss function, as shown by Equation 11:

$${ℒ}_{sigmoid} ( {x}_{i} ; B ) = - {log p}_{ij}^{sig} + {\sum }_{j = 1}^{b} log ( 1 - {ρ}_{i j}^{s i g} ) \qquad ( 11 )$$

where the system minimizes the negative log-likelihood

$$- log {p}_{i j}^{s i g}$$

of the positive image-text pair (i,j) while also maximizing the likelihood that all other pairs in the batch 124 are dissimilar through the

$${\sum }_{j = 1}^{b} log ( 1 - {ρ}_{i j}^{s i g} )$$

term to encourage the correct image-text pair to receive a high similarity score under

$${p}_{i j}^{s i g}$$

while pushing non-matching pairs toward low similarity scores. As such, the cross-entropy (CE) loss can be represented by Equation 12 as:

$$ℒ ( {x}_{i} ; B ) = {\sum }_{j = 1}^{b} {y}_{i} ( {x}_{i} ) {log p}_{ij} = CE [ y ( {x}_{i} ) ; p ( {x}_{i} ) ] \qquad ( 12 )$$

where y(xᵢ) represents the ground-truth distribution over candidate pairs for the input xᵢ, and p(xᵢ) represents the predicted distribution computed by the student machine learning model 112.

In some examples, as shown by ACED-IIDistill 204 and ACED-ACIDistill 206, the system 100 can further train the student machine learning model 112 using a knowledge distillation (KD) loss.

In both cases, the system can use the probability distributions p(xᵢ) generated by the teacher machine learning model 110 as target for the student's predicted distributions q(xᵢ), as shown by Equations 13 and 14:

$${ℒ}_{d} ( {x}_{i} ; B ) = KD [ p ( {x}_{i} ) ; q ( {x}_{i} ) ] = - \frac{1}{2} {\sum }_{j = 1}^{b} ( {p}_{i , j}^{img \to txt} {log q}_{i , j}^{img \to txt} + {p}_{i , j}^{txt \to img} {log q}_{i , j}^{txt \to img} ) \qquad ( 13 )$$

$${ℒ}_{full} = {ℒ}_{softmax / sigmoid} [ {B}_{CE} ] + λ \cdot {ℒ}_{dist} [ {B}_{KD} ] \qquad ( 14 )$$

where the distillation loss is defined as a KL divergence, where

$${p}_{i , j}^{img \to txt} and {p}_{i , j}^{txt \to img}$$

are the teacher model probabilities for aligning the i-th input with the j-th candidate, where

$${q}_{i , j}^{img \to txt} and {q}_{i , j}^{txt \to img}$$

are the corresponding probabilities generated by the student machine learning model 112, where [symbol] represents the contrastive loss (e.g., the softmax loss of Equation 7 and/or the sigmoid loss of Equation 8) computed on the selected batch B_{CE}, where [symbol] [B_{KD}] represents the distillation loss of Equation 10 computed on the random batch 208, B_{KD}. The random batch 208 is a subset of training examples 116 that is sampled uniformly at random from the training database 114 without using the active data selection procedure, which allows the system to perform knowledge distillation for the student machine learning model 112 using a broader, unbiased distribution of examples while still benefiting from the contrastive training on high-quality training examples.

In ACED-IIDistill 204, the two losses are computed on different batches (a curated batch for contrastive loss and a random batch for distillation loss), whereas in ACED-ACIDistill 206 the same curated batch 124 is used for both losses, so that the student machine learning model 112 is trained simultaneously on the contrastive objective and on aligning with the probability distributions for the teacher machine learning model 110 for the same selected training examples.

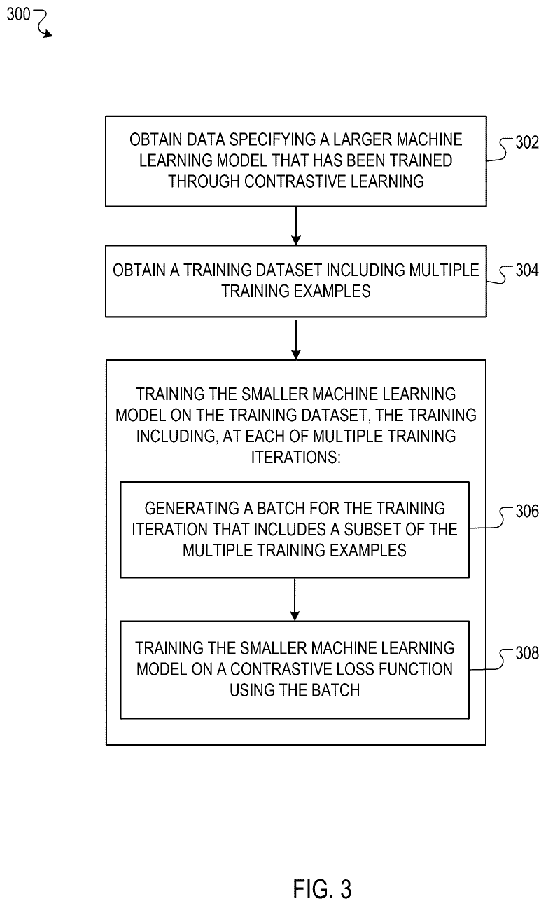

FIG. 3 is a flow diagram of an example process 300 for training a smaller machine learning model through contrastive learning using a batch that includes a subset of training examples in a dataset. For convenience, the process 300 will be described as being performed by a system of one or more computers located in one or more locations. For example, a system, e.g., the system 100 of FIG. 1, appropriately programmed, can perform the process 300.

The system can obtain data specifying a larger machine learning model (302). The larger machine learning model (e.g., the teacher machine learning model) has been trained through contrastive learning, and the larger machine learning model has more parameters than the smaller machine learning model.

The system can obtain a training dataset including multiple training examples (304).

The system can train the larger machine learning model on the training dataset, the training including, at each of multiple iterations, generating a batch for the training iteration that includes a subset of the multiple training examples (306). The generating includes selecting the subset of training examples according to performing an active data selection procedure that is based on respective contrastive losses of the larger machine learning model on one or more candidate batches that each include a respective subset of training examples from the training dataset.

The contrastive loss of the larger machine learning model on one of the candidate batches depends on, for each training example in the candidate batch, (i) a similarity between the first and second inputs in the training example and (ii) a respective similarity between the first input in the training example and each second input in each other training example that is included in the candidate batch. In some examples, the contrastive loss function is a softmax contrastive loss function. In some examples, the contrastive loss function is a sigmoid contrastive loss function.

In some examples, training the smaller machine learning model on the training dataset includes holding the larger machine learning model fixed during the training.

In some examples, performing the active data selection procedure includes determining, for each of the one or more of the training examples in the training dataset, a respective active data selection conditional score. The active data selection conditional score measures a benefit to the training of the smaller machine learning model of including the training example in the batch given that at least a subset of the training examples in the training dataset are also included in the batch.

In some examples, generating the batch for the training iteration includes adding a respective set of training examples to the batch at each of the multiple training iterations.

In some examples, selecting the subset of training examples includes: at one or more of the multiple training iterations, computing a respective active data selection conditional score for each of the training examples that are not included in the batch as of the iteration, where the active data selection conditional score measures a benefit to the training of the smaller machine learning model of including the training example in the batch given that at least the training examples that are already included in batch as of the iteration are also included in the batch. The system can then select the respective set of training examples to be added to the batch at the iteration based on the respective active data selection conditional scores for the training examples that are not included in the batch.

In some examples, selecting the respective set of training examples to be added includes determining a respective probability for each of the training examples that have not yet been included in the batch. The probability distribution can be based on the respective active data selection conditional scores for the training examples that are not included in the batch, and the system can sample the next subset of training examples to be added to the batch in accordance with the respective probabilities.

In some examples, determining a respective active data selection conditional score for each training example includes determining a first score that measures a contrastive loss of the larger machine learning model computed for a batch of training examples that includes the given training example and at least the subset of the training examples of the training dataset. The first score corresponds to the easy-reference score described above with reference to FIGS. 1 and 2. In some examples, for each training example in the subset, respective outputs of the larger machine learning model for the training example have been pre-computed and stored in a cache, and the system can compute the first score using outputs retrieved from the cache.

In some examples, determining the respective active data selection conditional score for each training example further includes determining a second score that measures a contrastive loss of the smaller machine learning model computed for the batch of training examples that includes the given training example and at least the subset of the training examples of the training dataset. The second score corresponds to the learnability score. The system can then combine the easy-reference score and the learnability score to determine the conditional benefit score for each training example, as described above with reference to Equation 1.

The training further includes training the smaller machine learning model on a contrastive loss function using the batch (308).

In some examples, the system can train the smaller machine learning model on a softmax distillation objective using a second subset of training examples. In this case, the teacher machine learning model 110 processes the second subset to generate teacher outputs, while the student machine learning model 112 processes the same subset to generate corresponding student outputs.

In particular, the teacher machine learning model 110 generates a set of larger similarity scores for each training example in the second subset, while the student machine learning model 112 can generate a corresponding set of smaller similarity scores. The system 100 then applies a cross-entropy loss between the larger similarity scores and the smaller similarity scores, which encourages the student machine learning model 112 to align its similarity distributions with those of the teacher machine learning model 110.

In some examples, the system can train the smaller machine learning model on a softmax distillation objective using a second subset of training examples. In particular, the system can process the second subset of training examples using the larger machine learning model to generate corresponding larger machine learning outputs and process the second subset of training examples using the smaller machine learning model to generate corresponding smaller machine learning outputs. The system can then train the smaller machine learning model on a cross-entropy loss between the larger machine learning outputs and the smaller machine learning outputs.

In another example, the system can train the smaller machine learning model on a sigmoid distillation objective, where the teacher machine learning model 110 and the student machine learning model 112 can both generate full image-text logits, which the system can pass through a sigmoid activation to produce probabilities, and the system can compute binary cross-entropy loss is computed between the teacher and student outputs.

In another example, the system can train the smaller machine learning model on a feature-matching distillation objective by aligning the embeddings generated by the teacher machine learning model 110 and the student machine learning model 112. That is, when the embedding dimensions differ between the teacher outputs and the student outputs, the system projects the student embeddings onto a teacher embedding space using a learnable projection head. The system then applies a mean-squared error loss between the teacher outputs and student outputs.

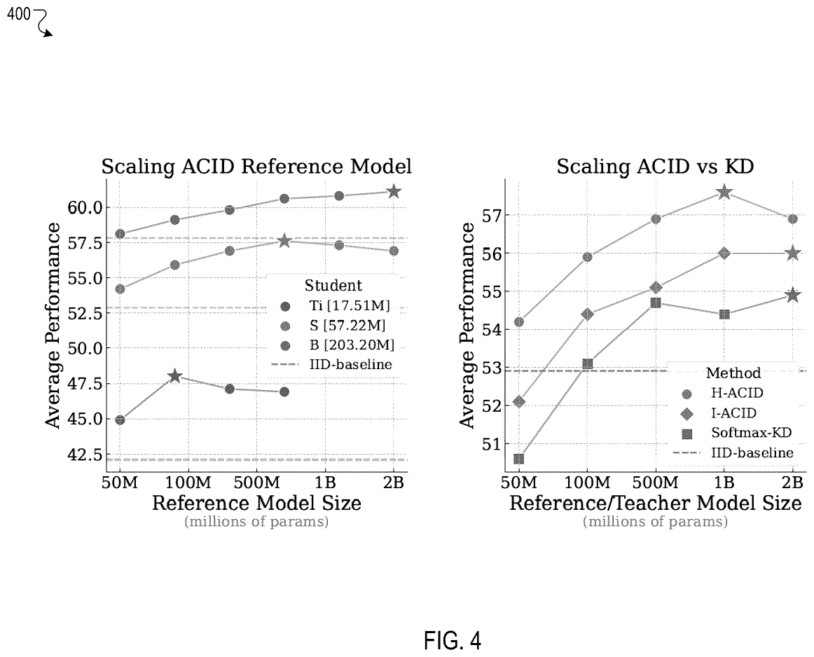

FIG. 4 is a diagram of example results of training a smaller machine learning model using active data selection.

The graphs of FIG. 4 illustrate the effectiveness of scaling active data selection relative to model size and training method. The left graph shows performance of student models of different sizes (Ti (“Tiny”), S (“Small”), B (“Base”)) when trained with Active Contrastive Distillation (ACID) as the model size increases. The right graph compares ACID-based methods (H-ACID, I-ACID) to a softmax-based knowledge distillation baseline (Softmax-KD) across a range of teacher model sizes. Average performance is reported across multiple evaluation benchmarks.

In particular, the left-most graph of FIG. 4 shows that larger reference models improve the performance of student models with consistent gains above IID baselines. Additionally, the right-most graph of FIG. 4 shows that ACID-based training outperforms softmax knowledge distillation across model scales, which demonstrates that active data selection yields more learnable batches and more effective knowledge transfer from larger reference models.

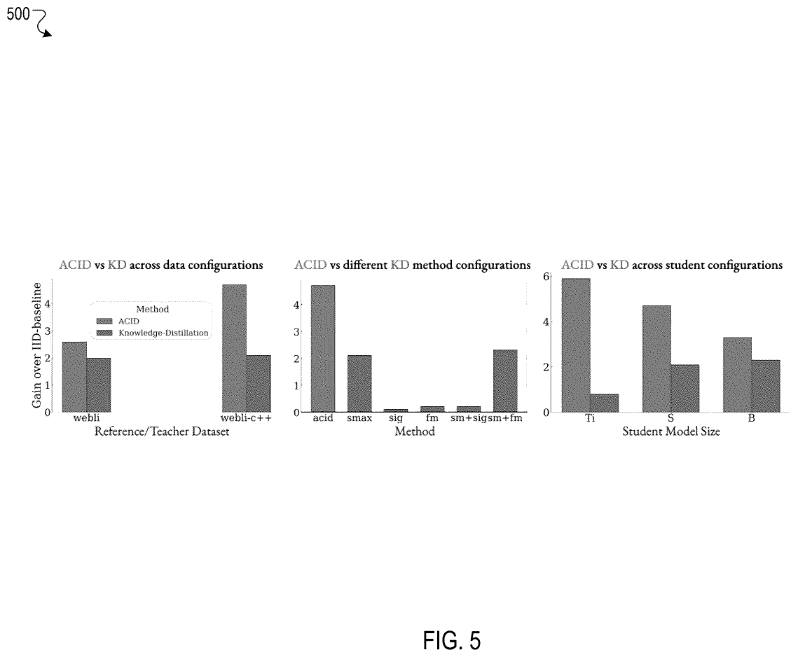

FIG. 5 is a diagram of example results of training a smaller machine learning model using active data selection for multimodal learnability.

The graphs of FIG. 5 illustrate the results of active data selection (ACID) compared to knowledge distillation (KD) baselines across multiple training configurations. In particular, the left-most graph shows performance gains over IID baselines when varying the teacher dataset (e.g., WebLI vs. WebLI-c++). The middle graph shows performance when using different KD method configurations (e.g., softmax-based distillation, sigmoid-based distillation, feature-matching approaches). The right-most graph shows performance across different student model sizes (Ti, S, B).

In particular, FIG. 5 demonstrates that ACID consistently outperforms KD across all evaluated conditions. ACID yields higher gains when scaling to enhanced datasets, achieves stronger performance relative to multiple KD variants, and provides larger improvements for smaller student models. These results highlight that active data selection produces more learnable training batches and more effective knowledge transfer than conventional distillation techniques.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers and for training a smaller machine learning model through contrastive learning, the method comprising:
obtaining data specifying a larger machine learning model, wherein the larger machine learning model has been trained through contrastive learning, and wherein the larger machine learning model has more parameters than the smaller machine learning model;
obtaining a training dataset comprising a plurality of training examples; and
training the smaller machine learning model on the training dataset, the training comprising, at each of a plurality of training iterations:
generating a batch for the training iteration that comprises a subset of the plurality of training examples, the generating comprising selecting the subset of training examples according to performing an active data selection procedure that is based on respective contrastive losses of the larger machine learning model on one or more candidate batches that each include a respective subset of training examples from the training dataset; and
training the smaller machine learning model on a contrastive loss function using the batch.

2. The method of claim 1, wherein training the smaller machine learning model on the training dataset further comprises:
holding the larger machine learning model fixed during the training.

3. The method of claim 1, wherein performing the active data selection procedure comprises:
determining, for each of the one or more of the training examples in the training dataset, a respective active data selection conditional score, wherein the active data selection conditional score measures a benefit to the training of the smaller machine learning model of including the training example in the batch given that at least a subset of the training examples in the training dataset are also included in the batch.

4. The method of claim 1, wherein generating the batch for the training iteration comprises:
adding a respective set of training examples to the batch at each of the plurality of training iterations.

5. The method of claim 4, wherein selecting the subset of training examples further comprises:
at one or more of the plurality of training iterations:
computing a respective active data selection conditional score for each of the training examples that are not included in the batch as of the iteration, wherein the active data selection conditional score measures a benefit to the training of the smaller machine learning model of including the training example in the batch given that at least the training examples that are already included in the batch as of the iteration are also included in the batch; and
selecting the respective set of training examples to be added to the batch at the iteration based on the respective active data selection conditional scores for the training examples that are not included in the batch.

6. The method of claim 5, wherein selecting the respective set of training examples to be added comprises:
determining a respective probability for each of the training examples that are not included in the batch using the respective active data selection conditional scores for the training examples that are not included in the batch; and
sampling the respective set of training examples in accordance with the respective probabilities.

7. The method of claim 3, wherein determining, for each of one or more of the training examples in the training dataset, a respective active data selection conditional score comprises, for each of the one or more training examples:
determining a first score that measures a contrastive loss of the larger machine learning model computed for a batch of training examples that includes the given training example and at least the subset of the training examples of the training dataset.

8. The method of claim 7, wherein, for each training example in the subset, respective outputs of the larger machine learning model for the training example have been pre-computed and stored in a cache, and wherein the method further comprises:
computing the first score using outputs retrieved from the cache.

9. The method of claim 7, wherein determining, for each of one or more of the training examples in the training data set, a respective active data selection conditional score further comprises, for each of the one or more training examples:
determining a second score that measures a contrastive loss of the smaller machine learning model computed for the batch of training examples that includes the given training example and at least the subset of the training examples of the training dataset.

10. The method of claim 1, wherein the contrastive loss of the larger machine learning model on one of the candidate batches depends on, for each training example in the candidate batch, (i) a similarity between the first and second inputs in the training example and (ii) a respective similarity between the first input in the training example and each second input in each other training example that is included in the candidate batch.

11. The method of claim 10, wherein the contrastive loss function is a softmax contrastive loss function.

12. The method of claim 10, wherein the contrastive loss function is a sigmoid contrastive loss function.

13. The method of claim 1, wherein training the smaller machine learning model further comprises:
training the smaller machine learning model on a softmax distillation objective using a second subset of training examples.

14. The method of claim 13, wherein training the smaller machine learning model on a softmax distillation objective comprises:
processing the second subset of training examples using the larger machine learning model to generate corresponding larger machine learning outputs;
processing the second subset of training examples using the smaller machine learning model to generate corresponding smaller machine learning outputs; and
training the smaller machine learning model on a cross-entropy loss between the larger machine learning outputs and the smaller machine learning outputs.

15. The method of claim 14, wherein the larger machine learning outputs comprise a set of larger similarity scores for each of the training examples in the second subset, and wherein the smaller machine learning outputs comprise a set of smaller similarity scores for each of the training examples in the second subset.

16. The method of claim 1, wherein, for each training example, the respective first input is of a first modality and the respective second input is of a second, different modality.

17. The method of claim 16, wherein the first modality is one of an image, audio, video, or text, and wherein the second modality is one of an image, audio, video, or text.

18. The method of claim 1, further comprising:
processing one or more inputs using the trained smaller machine learning model to generate one or more embedding outputs for a downstream task.

19. A system comprising:
one or more computers; and
one or more storage devices communicatively coupled to the one or more computers, wherein the one or more storage devices store instructions that, when executed by the one or more computers, cause the one or more computers to perform operations comprising:
obtaining data specifying a larger machine learning model, wherein the larger machine learning model has been trained through contrastive learning, and wherein the larger machine learning model has more parameters than the smaller machine learning model;
obtaining a training dataset comprising a plurality of training examples; and
training the smaller machine learning model on the training dataset, the training comprising, at each of a plurality of training iterations:
generating a batch for the training iteration that comprises a subset of the plurality of training examples, the generating comprising selecting the subset of training examples according to performing an active data selection procedure that is based on respective contrastive losses of the larger machine learning model on one or more candidate batches that each include a respective subset of training examples from the training dataset; and
training the smaller machine learning model on a contrastive loss function using the batch.

20. One or more non-transitory computer storage media storing instructions that when executed by one or more computers cause the one or more computers to perform operations comprising:
obtaining data specifying a larger machine learning model, wherein the larger machine learning model has been trained through contrastive learning, and wherein the larger machine learning model has more parameters than the smaller machine learning model;
obtaining a training dataset comprising a plurality of training examples; and
training the smaller machine learning model on the training dataset, the training comprising, at each of a plurality of training iterations:
generating a batch for the training iteration that comprises a subset of the plurality of training examples, the generating comprising selecting the subset of training examples according to performing an active data selection procedure that is based on respective contrastive losses of the larger machine learning model on one or more candidate batches that each include a respective subset of training examples from the training dataset; and
training the smaller machine learning model on a contrastive loss function using the batch.
